(19) United States
(12) Patent Application Publication
(10) Pub. No.: US 2006/0146441 A1
(43) Pub. Date: Jul. 6, 2006

(54) External/removable hard disk drive tray

(76) Inventor: Yung-Chao Chih, Taoyuan County (TW)

Correspondence Address: Yung-Chao Chih, 9F., No. 37 Dongsing Road, Xinyi District, Taipei City, 110, TW

(21) Appl. No.: 11/027,319

(22) Filed: Jan. 3, 2005

(51) Int. Cl. G11B 17/00

(52) U.S. Cl. 360/97.01

(57) ABSTRACT

An external/removable hard disk drive tray includes a main housing, and a first and a second end cap inserted into two opposite open ends of the main housing. The main housing defines an internal space, in which a carrier is disposed. The carrier has two opposite ends projected from the two open ends of the main housing and provided with a plurality of fastening holes. The first and the second end cap are respectively formed with through holes corresponding to the fastening holes on the carrier, so that fasteners may be screwed into the fastening holes on the carrier via the through holes on the first and the second end cap, enabling the external/removable hard disk drive tray to be produced with simplified procedures and at reduced manufacturing cost while having minimized accumulated errors and enhanced structure.

### FIELD OF THE INVENTION

The present invention relates to an external/removable hard disk drive tray, and more particularly to an external/removable hard disk drive tray that has end caps screwed to a carrier in a main housing of the tray to minimize the accumulated errors, simplify the production, reduce the manufacturing cost, and enhance the structure of the fully assembled tray.

### BACKGROUND OF THE INVENTION

FIGS. 1 and 2 are exploded and assembled perspective views, respectively, of a conventional external/removable hard disk drive tray 1. As shown, the external/removable hard disk drive tray 1 includes a main housing 11, and a first and a second end cap 12, 13 closed to two opposite open ends of the main housing 11. The main housing 11 is provided at each lateral side of the two opposite open ends with a through hole 111. The first and the second end cap 12, 13 are provided at respective inner side facing toward the open ends of the main housing 11 with two forward projected locking lug pairs 121, 131, respectively, corresponding to the open ends of the main housing 11. There is a through hole provided on each locking lug of the locking lug pairs 121, 131. A reinforcing member 122, 132 having a through hole provided thereon is clamped between each locking lug pair 121, 131. When the first and the second end cap 12, 13 are closed onto the two opposite open ends of the main housing 11, the two locking lug pairs 121, 131 and the two reinforcing members 122, 132 on the two end caps 12, 13, respectively, are inserted into the main housing 11 with the through holes on the locking lugs and the reinforcing members aligned with corresponding through holes 111 at two lateral sides of the main housing 11. Fasteners can be then screwed through the aligned through holes to lock the first and the second end cap 12, 13 to the main housing 11 via the locking lug pairs 121, 131 and the reinforcing members 122, 132, as shown in FIG. 2.

Generally, the main housing, the reinforcing members, and the fasteners (usually screws) are made of metal materials, while the first and the second end cap as well as the forward projected locking lug pairs are made of a plastic material. When the main housing are connected to the reinforcing members and the locking lug pairs using fasteners, the locking lug pairs are the most important bridges between the first and second end caps and the main housing. However, the locking lugs in each locking lug pair are made of plastic material and thin, and are subject to deformation due to temperature or breaking due to improper application of force when screwing the fasteners therethrough, preventing the end caps from firmly connecting to the main housing. Moreover, since the reinforcing member clamped between each locking lug pair is not provided with any stop mechanism and the through holes on the main housing are manually formed at a later fabricating stage of the removable hard disk drive tray, the allowable tolerances of the through holes on the main housing, the locking lug pairs, and the reinforcing members accumulate, and there will be a relative offset error between the through holes on the main housing and the reinforcing members. All these factors result in seriously accumulated errors. Furthermore, the locking lugs are not thick enough to play the role of leading the fasteners into a correct screwing path. That is, the fasteners screwed into the main housing, the reinforcing members, and the locking lug pairs tend to become biased and cause slipped threads on the reinforcing members and accordingly, an improperly assembled removable hard disk drive tray. The first and the second end cap are subject to damage when they are dismounted from and reassembled to the main housing, resulting in defects in the appearance and quality of the finished product.

Another problem with the conventional external/removable hard disk drive tray is the high labor cost thereof. This is because the main housing of the conventional external/removable hard disk drive tray are manually drilled to produce the through holes thereon for associating with the end caps. Sometimes, the labor cost is almost as high as or even higher than the material cost of the main housing. In addition, the end caps and the reinforcing members are also manually assembled to the main housing to further increase the labor and overall costs of the conventional external/removable hard disk drive tray.

It is therefore tried by the inventor to develop an improved external/removable hard disk drive tray to eliminate the drawbacks existed in the conventional ones.

### SUMMARY OF THE INVENTION

A primary object of the present invention is to provide an external/removable hard disk drive tray that has end caps directly screwed to a carrier in a main housing of the tray via through holes and fastening holes provided on the end caps and the carrier, respectively, to minimize the accumulated errors, simplify the production, reduce the manufacturing cost, and enhance the structure of the fully assembled external/removable hard disk drive tray.

To achieve the above and other objects, the external/removable hard disk drive tray of the present invention includes a main housing, and a first and a second end cap inserted into two opposite open ends of the main housing. The main housing defines an inner space, in which a carrier is disposed. The carrier has two opposite ends projected from the two open ends of the main housing and provided with a plurality of fastening holes. The first and the second end cap are respectively formed at an inner end with an engaging section having an outer perimeter slightly smaller than that of the main housing, and at a lower side with through holes corresponding to the fastening holes on the carrier, so that fasteners are directly screwed into the fastening holes on the carrier via the through holes on the first and the second end cap, enabling the external/removable hard disk drive tray to be produced with simplified procedures and at reduced manufacturing cost while the accumulated error is minimized and the structure is enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded top perspective view of a conventional external/removable hard disk drive tray;

FIG. 2 is an assembled perspective view of FIG. 1;

FIG. 3 is an exploded bottom perspective view of an external/removable hard disk drive tray according to an embodiment of the present invention;

FIG. 4 is an exploded bottom perspective view of an external/removable hard disk drive tray according to another embodiment of the present invention;

FIG. 5 is an assembled perspective view of the external/removable hard disk drive tray of the present invention;

FIG. 6 is a fragmentary sectioned side view of the external/removable hard disk drive tray of FIG. 3; and

FIG. 7 is a fragmentary sectioned side view of the external/removable hard disk drive tray of FIG. 4.

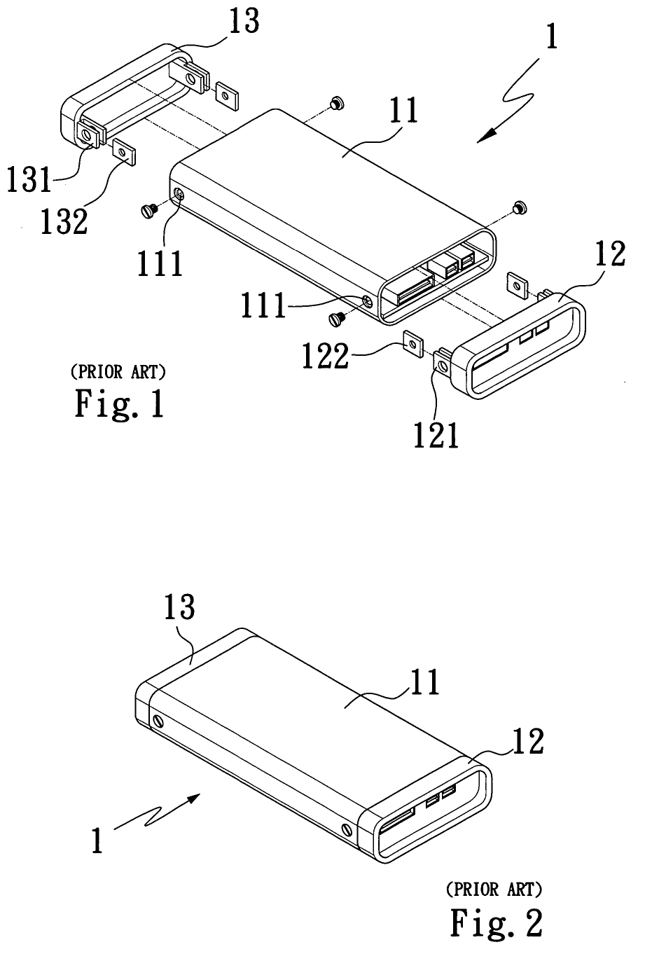

### DETAILED DESCRIPTION OF THE PREFERRED EMBODIMENTS

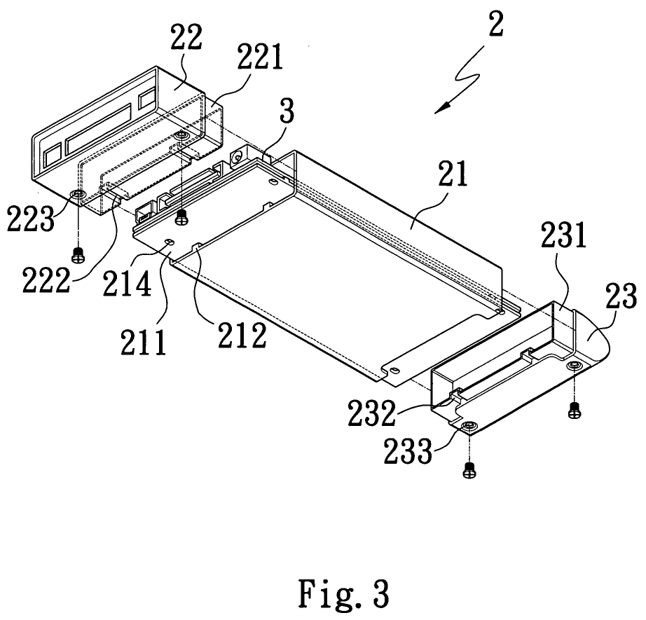

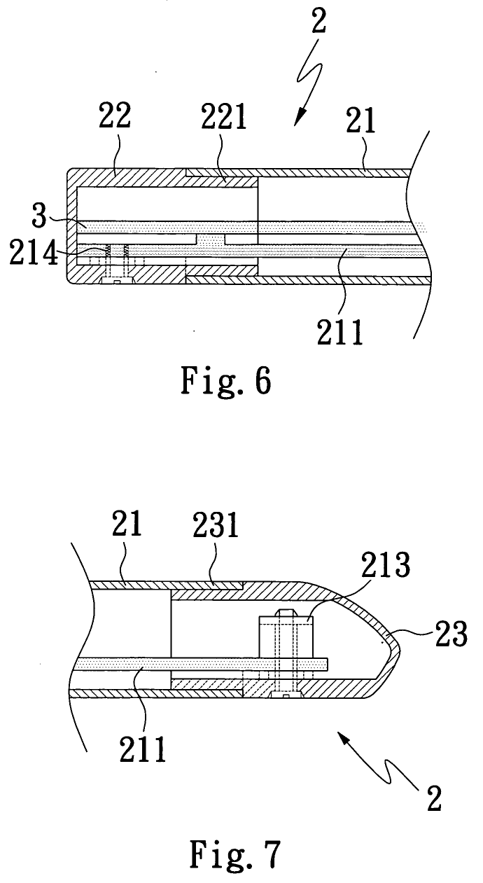

Please refer to FIG. 3 that is an exploded bottom perspective view of an external/removable hard disk drive tray 2 according to an embodiment of the present invention. As shown, the external/removable hard disk drive tray 2 includes a main housing 21, and a first and a second end cap 22, 23 separately inserted into two opposite open ends of the main housing 21. The main housing 21 is provided on an inner bottom surface with two longitudinally extended ribs 212. A circuit board 3 and a carrier 211 having electronic components mounted thereon are set in an internal space defined by the main housing 21. The carrier 211 has two opposite ends projected from the two open ends of the main housing 21 and provided with a plurality of fastening holes 214. The first and the second end cap 22, 23 are respectively formed at an inner end with an engaging section 221, 231, which have an outer perimeter slightly smaller than that of the main housing 21 and are provided at a lower inner end with two recesses 222, 232 each. The first and the second end cap 22, 23 are also provided at a lower side with through holes 223, 233, respectively, corresponding to the fastening holes 214 on the carrier 211, so that fasteners, such as screws, may be screwed into the fastening holes 214 via the through holes 223, 233 (also see FIG. 6).

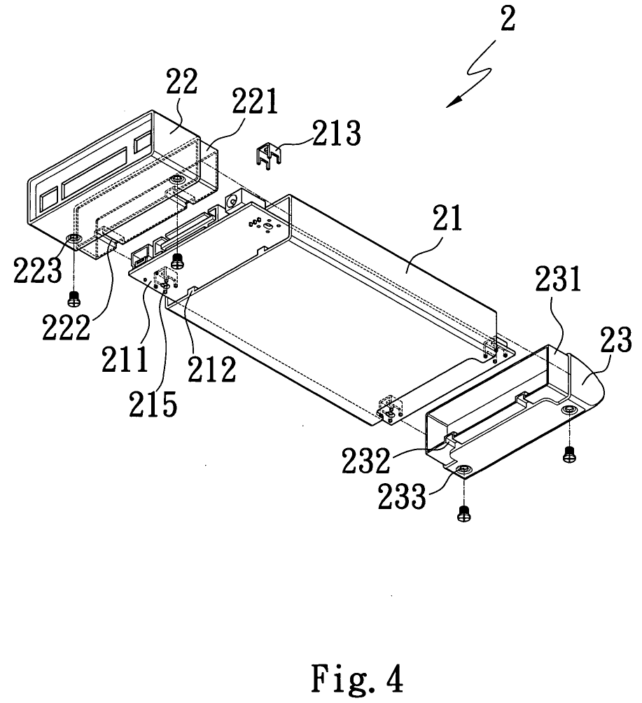

FIG. 4 is an exploded bottom perspective view of an external/removable hard disk drive tray 2 according to another embodiment of the present invention. In this embodiment, the electronic components are directly mounted on the carrier 211 in the main housing 21. Again, the carrier 211 has two ends that are projected from the two open ends of the main housing 21 and are provided with a plurality of fastening holes 215. A reversed U-shaped locking member 213 is correspondingly provided on the carrier 211 directly above each of the fastening holes 215 (also see FIG. 7). Each of the reversed U-shaped locking members 213 is provided at a top with a screw hole corresponding to the fastening hole 215 of the carrier 211 below the locking member 213. However, it is noted the screw hole may be formed not only at the top of the reversed U-shaped locking member 213, but also at another two sides of the locking member 213. Similarly, the external/removable hard disk drive tray 2 according to the second embodiment of the present invention has first and second end caps 22, 23, which are respectively formed at an inner end with an engaging section 221, 231 having an outer perimeter slightly smaller than that of the main housing 21 and provided at a lower inner end with two recesses 222, 232 each. The first and the second end cap 22, 23 are also provided at a lower side with through holes 223, 233, respectively, corresponding to the screw holes on the reversed U-shaped locking members 213, so that fasteners, such as screws, may be screwed through the through holes 223, 233 on the first and the second end cap 22, 23, respectively, into the reversed U-shaped locking members 213 on the carrier 211 (also see FIG. 7).

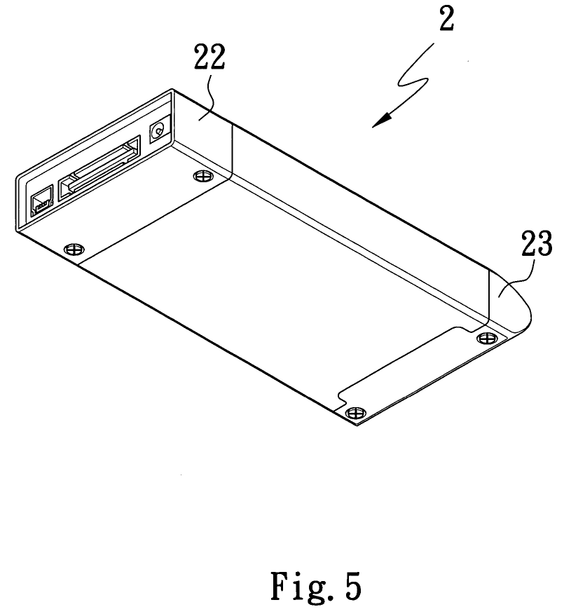

With the above arrangements, the engaging sections 221, 231 of the first and the second end cap 22, 23 are slid into the two open ends of the main housing 21 with the recesses 222, 232 engaged with the ribs 212 on the inner bottom surface of the main housing 21, so that fasteners may be screwed into the screw holes of the reversed U-shaped locking members 213 on the carrier 211 via the through holes 223, 233 on the first and the second end cap 22, 23. At this point, the reversed U-shaped locking members 213, which are structurally strong, produce a downward pressure against the carrier 211, as shown in FIG. 7, to bring the first and the second end cap 22, 23 and the main housing 21 to more firmly associate with one another. Moreover, the reversed U-shaped locking members 213 provided on the carrier 211 also function to lead the fasteners or screws into correct fastening paths, so that the fully assembled external/removable hard disk drive tray 2 as shown in FIG. 5 has minimized accumulated errors and may be produced with simplified procedures and at reduced manufacturing cost to achieve enhanced structure through screwing.

What is claimed is:

1. An external/removable hard disk drive tray, comprising a main housing, and a first and a second end cap inserted to two opposite open ends of said main housing; said main housing defining an internal space, in which a carrier is disposed; said carrier having two opposite ends projected from the two open ends of said main housing and provided with a plurality of fastening holes; and said first and said second end cap being respectively formed at an inner end with an engaging section, which have an outer perimeter slightly smaller than that of said main housing and are provided with through holes corresponding to said fastening holes on said carrier, so that fasteners are screwed into said fastening holes on said carrier via said through holes on said first and said second end cap.

2. The external/removable hard disk drive tray as claimed in claim 1, further comprising a plurality of reversed U-shaped locking members correspondingly located above said fastening holes on said carrier; and each of said reversed U-shaped locking members being provided with at least one screw hole corresponding to said fastening hole on said carrier.

3. The external/removable hard disk drive tray as claimed in claim 1, wherein said engaging sections of said first and said second end cap are provided at respective lower inner end with two recesses, and said main housing being provided on an inner bottom surface with two ribs adapted to slidably engage with said two recesses on said first and said second end cap.

4. The external/removable hard disk drive tray as claimed in claim 2, wherein each of said reversed U-shaped locking members is provided on each of three sides thereof with one said screw hole.
